(19) United States
(12) Patent Application Publication
(10) Pub. No.: US 2008/0148623 A1
(43) Pub. Date: Jun. 26, 2008

(54) Fishing jig

(76) Inventor: Robert Uhrig, Jackson, NJ (US)

Correspondence Address: Francis C. Hand, Esq.;c/o Carella, Byrne, Bain, Gilfillan,, Cecchi, Stewart & Olstein, 5 Becker Farm Road, Roseland, NJ, 07068, US

(21) Appl. No.: 11/644,360

(22) Filed: Dec. 21, 2006

Related U.S. Application Data
(63) Continuation-in-part of application No. 11/487,944, now abandoned.

(51) Int. Cl. A01K 85/02; A01K 85/00

(52) U.S. Cl. 43/42.39; 43/42.4; 43/44.8; 43/42.42

(57) ABSTRACT

The fishing jig has a molded body with a curved bottom surface that allows the body to pivot on a flat surface. A head projecting from the body acts as a counterweight to a hook extending from the body opposite the head to cause the jig to pivot when resting on a flat surface so that the hook is placed in a raised position. A weed guard is provided that is substantially invisible in water and a front-mounted skirt with trailers is mounted between the head and body to hide the hook and weed guard in use.

This application is a continuation-in-part of application Ser. No. 11/487,944 filed Jul. 17, 2006.

This invention relates to a fishing jig. More particularly, this invention relates to a fishing jig with a weed guard.

As is known, various types of fishing jigs have been used to catch fish, particularly, bass. For example, as described in U.S. Pat. No. 4,596,086, fishing jigs have been provided with a hook and a flexible plastic skirt having tails which are intended to jiggle in the water as the fishing jig passes through the water. In addition, such fishing jigs have been provided with a weed guard in the form of a soft plastic elongated member into which the fishing hook can be embedded in order to avoid snagging of the hook on weeds, branches or other submerged debris. However, when the fishing jig is bitten by a fish, a barbed tip on the hook is to pass through the weed guard into the fish.

Still other types of weed guards for jigs are known, for example from U.S. Pat. No. 6,772,553 wherein a plurality of plastic bristles are secured in a jig and project outwardly within the plane of a fishing hook.

Typically, when fishing for predatory fish, such as bass, the fishing jigs are caused to sink to the bottom of the stream or other body of water to lie in wait for a bass to become attracted to the jig. In some cases, the jigs are moved so that the tails of a plastic skirt secured to the jig create movement to further attract the fish. However, based upon experience, it appears that bass are wary of fishing jigs that have hooks and weed guard that are exposed to view. In such cases, the bass tend to avoid such jigs.

Accordingly, it is the object of the invention to provide a fishing jig in which a weed guard and fishing jig are concealed when in use.

It is another object in the invention to provide a fishing jig with a weed guard that is substantially invisible in water.

It is another object in the invention to provide a fishing jig that is able to present a lure for a predatory fish in an upstanding position.

It is another object in the invention to provide a fishing jig that is environmentally friendly.

Briefly, the invention provides a fishing jig that has a body with a longitudinally curved bottom surface, a hook that extends longitudinally from the body at one end and a head that extends from the body at an opposite end from the hook in coplanar relation to the hook. In accordance with the invention, the head is made of a weight greater than the weight of the hook in order to roll the body on the curved bottom surface in the direction of the head when the jig is resting on a flat surface of a body of water. The rolling motion is sufficient to allow the head to contact the flat surface thereby pivoting the hook into a raised position.

The head of the fishing jig is also provided with a recessed aperture at a forward end for receiving a fishing line or leader while a trailer keeper is provided on the hook adjacent to the body for retaining a lure, for example, in the shape of a crayfish thereon.

In addition, the fishing jig includes a collar that extends between the head and the body in order to receive a skirt with a plurality of trailers as well as a flat surface adjacent to the collar for splaying the trailers outwardly from the flat surface. In this respect, the skirt has an elastic band that allows the skirt to be slid over the head and into place about the collar while the trailers extend from the band and are of a length to extend beyond the hook.

The fishing jig is also provided with a weed guard that extends from the body between the head and the hook and that is disposed in alignment with the hook in order to protect against the hook snagging in weeds, trees and alike. In accordance with the invention, the weed guard is composed of a plurality of relatively stiff fibers of translucent material having a refractive index approximately equal to that of water. As is known, the refractive index of water is approximately 1.33. For example, the fibers are made up of fluorocarbon material, such as vinylidene fluoride as described in U.S. Pat. No. 4,521,483, which material is believed to have a refractive index of 1.415 or lower. When the jig is dropped into a body of water, the fibers of the weed guard becomes substantially invisible to the naked eye and to the eye of a bass or similar fish.

When in use, the fishing jig is dropped via a fishing line into a body of water and the body of the jig is allowed to contact the bottom of the body of water. Upon contact with the bottom, the weight of the head causes the body to pivot or roll on its curved bottom surface forwardly in the direction of the head so that the hook moves into a raised position with the crayfish-shaped lure being raised. As is known, when in a defensive mode, a crayfish raises its pincers to adopt a raised posture. This defensive position signals a bass or similar fish to stay away. However, by then pulling of the fishing line to move the fishing jig forwardly, the head of the jig becomes raised so that the hook drops downwardly thereby causing the crayfish shaped lure to move into a flattened non-defensive position. This signals to the bass that the crayfish is not in a defensive mode. Accordingly, the bass will then strike the jig and become impaled on the hook.

When the fishing jig is moved through a body of water, the trailers of the skirt are moved rearwardly in a splayed out fashion thereby concealing the fishing hook and any lure thereon as well as a substantial portion of the weed guard. Since the weed guard is substantially invisible, the fishing jig presents an attractive lure to a bass or other fish without any indication of a hook or weed guard being present.

The body of the fishing jig may also be curved transversely for rocking of the body from side to side on a flat surface to further enhance the ability of the jig to lure a fish.

The hook of the jig may be made of steel with the remainder of the jig being made of tin in order to be environmentally friendly. For example, the body and head of the jig may be molded into one piece with the hook embedded within the molded portions.

These and other objects in advantages from the following detailed description taken in conjunction with the accompany drawings wherein:

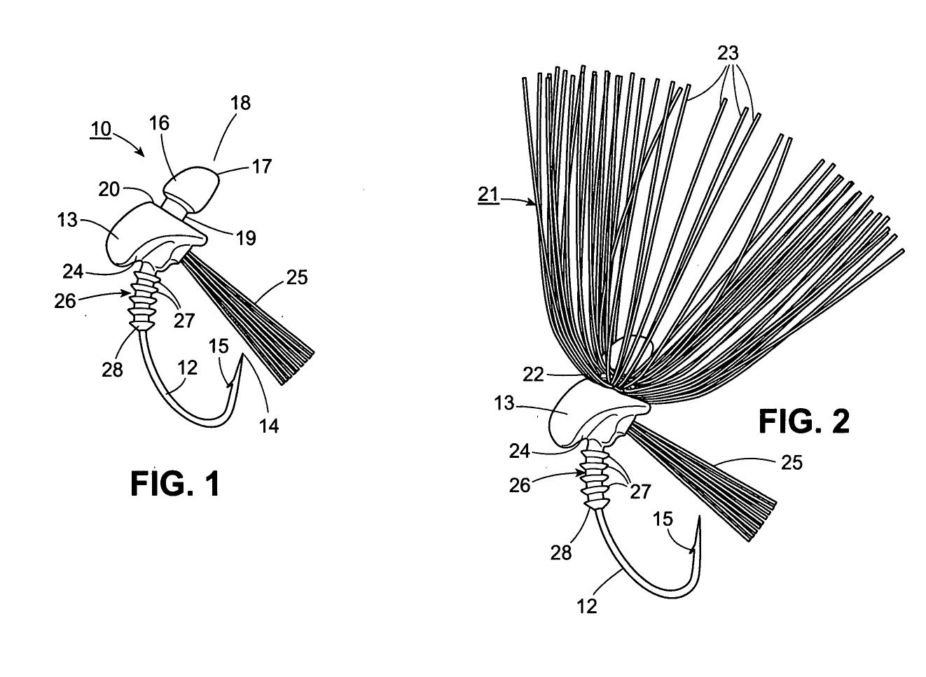

FIG. 1 illustrates a side view of a fishing jig constructed in accordance with the invention;

FIG. 2 illustrates a perspective view of a fishing jig having a skirt thereon in accordance with the invention;

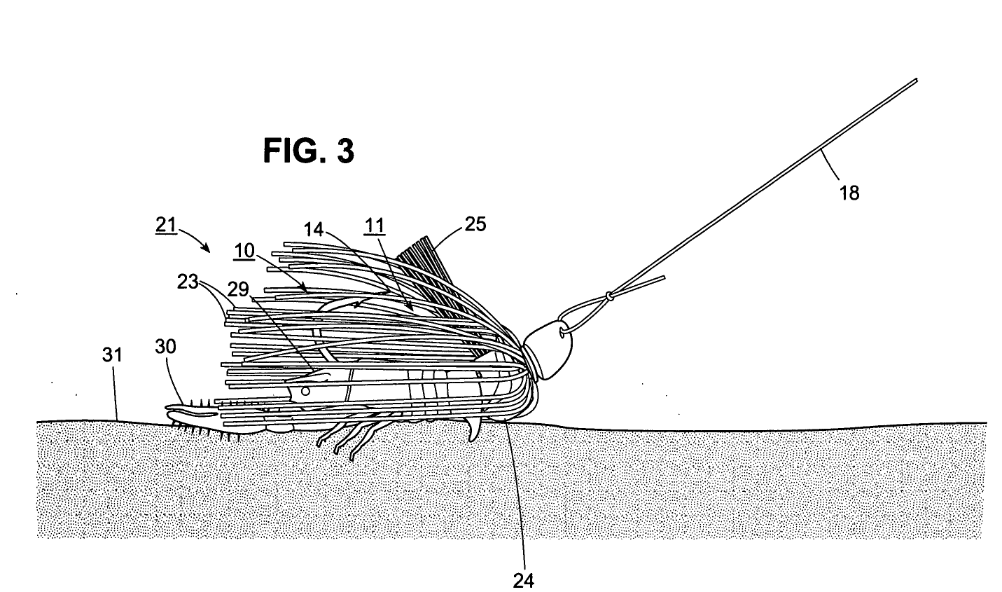

FIG. 3 illustrates a side view of the fishing jig of FIG. 1 with a crayfish lure thereon; and

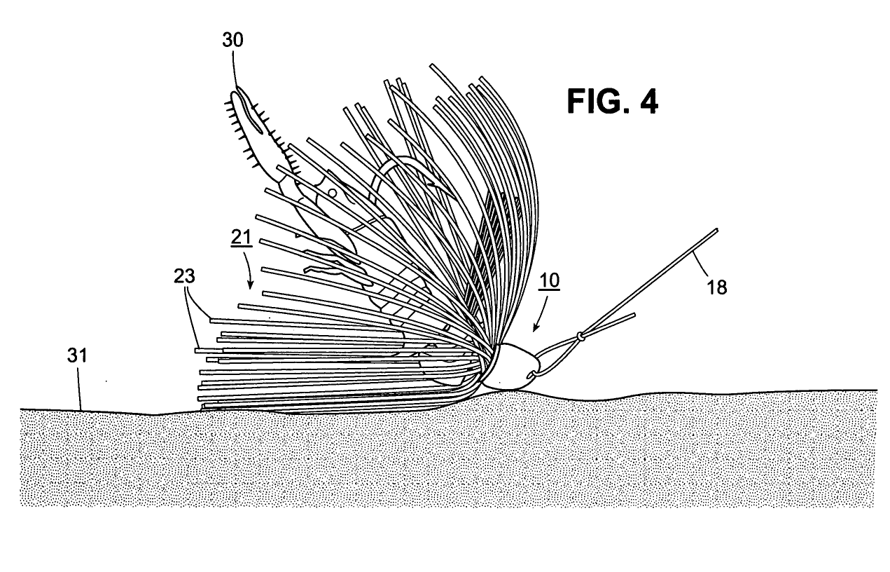

FIG. 4 illustrates the fishing jig of FIG. 1 with a crayfish lure in an upraised position in accordance with the invention.

Referring to FIG. 1, the fishing jig 10 is formed of a body 11 that is molded about a hook 12 to form a one-piece construction.

As illustrated, the body 11 has a longitudinally curved bottom surface 13 for pivoting on a flat surface as well as a transversely curved surface (not shown) for rocking from side to side on the flat surface. The body 11 may be sized to provide different weights from jig to jig and each body 11 may be embossed with indicia indicative of the weight of the jig 10.

The hook 12 extends longitudinally from the body 11 and is provided with a point 14 at one end as well as a barb 15 directed in an opposite direction to the point 14 in known manner. As illustrated, the hook 12 is curved on itself to be directed back toward the body 11.

The body 11 has a head 16 that extends from the body 11 at an opposite end from the hook 12 in coplanar relation to the hook 12 and is of a weight greater than the weight of the hook 12. The head 16 acts as a counterweight so that the greater weight of the head 15 causes the body 11 to roll when on a flat surface about the curved surface 13 in the direction of the head 16 so that the hook 12 is moved into a raised position.

The head 16 is provided with a recessed aperture 17 at the top end for receiving a fishing line or leader 18.

The jig 10 also has a collar 19 that extends between the head 16 and the body 11 and is of cylindrical shape whereas the head 16 is of a cobra-like shape. The body 11 has a flat surface adjacent to the collar 19 that forms a disk plate 20 for purposes as described below.

As illustrated in FIG. 2, a skirt 21 is disposed about the collar 19. This skirt 21 has an elastic band 22 that is able to expand and slide over the head 16 into place around the collar 19. When in place, the band 22 contracts and is held between the head 16 and the disk plate 20. In addition, the skirt 21 includes a plurality of buoyant trailers 23 that extend from the band 22 and that are of a length to extend beyond the hook 12. The trailers 23 are in the form of filaments that extend from both sides of the elastic band 22 and are of any suitable material, such as silicone, rubber, plastic, hair, feathers and the like. In addition, the trailers 23 may be made of any suitable color.

Since the skirt 21 is loaded from the front onto the collar 19 rather than being inserted over the hook 12, the mounting of the skirt 21 in place reduces the risk of injury from the sharp point 14 of the hook 12 and/or the barb 15 on the hook 12.

The disk plate 20 over which the trailers 23 extend serves to splay the trailers 23 outwardly from the collar 19 thereby providing an appearance of increased bulk.

The curved bottom surface 13 of the body 11 may be provided directly on the body 11 where the body 11 is of larger weight or may be provided on a skid plate 24, as shown in FIG. 1, that extends from the body 11 where the body 11 is of lighter weight. In either case, the curved bottom surface 13 acts as a fulcrum or pivot surface for pivoting of the hook 12 into an upraised position when resting on the bottom of a body of water.

The fishing jig 10 is also provided with a weed guard 25 that extends from the body 11 between the head 16 and the hook 12 on an opposite side of the body 11 from the skid plate 24. As illustrated, the weed guard 25 is disposed in alignment with the hook 12 and includes a plurality of stiff fibers of translucent material having a refraction index approximately equal to that of water. These fibers are made of a fluorocarbon material, such as vinylidene fluoride. Spools of such material are sold as invisible leader material and are available under the registered Trademark SEAGUAR® in the name of Kureha Kagaku Kogyo KK of Tokyo, Japan.

Being positioned forwardly of the weed guard 25, the skirt 21 is able to conceal the week guard 25 when being pulled through the water when in use. The skirt 21 also substantially obscures the weed guard 25 when lying on a bottom, for example, as indicated in FIG. 3.

The body 11 is provided with a recess (not shown), such as a circular recess, for receiving the fibers of the weed guard 25 in fixed relation, for example via a glue.

The body 11 also has trailer keeper 26 for the mounting of a lure (not shown) thereon. As illustrated, the keeper 26 is formed of a series spaced apart rings 27 each of which has a conical surface 28 on one side and a re-entrant surface (not shown) on the backside. The smooth conical surface 28 allows a lure to be slid over the series of rings 27 while the re-entrant surfaces are to dig into the lure to resist removal of the lure from the hook.

Referring to FIG. 3, a lure 29, for example in the shape of a crayfish, is impaled over the hook 12 and is slid over the keeper 26 with the outer end of the hook 12 projecting through the lure 29. The lure 29 may be made of any suitable material such as plastic and is formed with pincers 30 to simulate the natural appearance of a crayfish.

The weight of the fishing jig 10 is equally distributed underneath the disk plate 24 and hook 12 so that the jig 10 falls through the water in a balanced manner and slower than jigs that are forward weighted. Because of the equally distributed weight, when a jig 10 lands on the bottom 31 of a body of water, the jig 10 moves into an upright position. There is no more falling over because of improper balancing.

When used without the fishing lure 29, the jig 10 is pulled through a body of water with the trailers 23 splaying outwardly and rearwardly over the hook 12 and most of the weed guard 25. Upon landing on the bottom 31 of a body of water, the body 11 of then jig 10 pivots about the bottom surface 13 of the skid plate 24 forwardly under the weight of the head 16 thereby bringing the hook 12 into a raised position. Hopefully, a fish will strike the jig and become impaled by the hook 12. The jig 10 exhibits a tendency to land in the upright position due to the center of gravity being below the hook 12 and centered along the axis of the hook 12.

When used with the lure 29, the jig 10 comes to rest on the bottom 31 of the body of water, the added weight of the lure 29 prevents pivoting of the body 11. Thus, the lure 29 lays flat on the bottom 31 as shown in FIG. 3. At this time, the buoyant trailers 23 are splayed outwardly in an umbrella-like fashion by the disk plate 20 and, due to the buoyancy of the trailers 23, float upwardly as illustrated to substantially conceal the weed guard 25 and to conceal the hook 12.

Thereafter, pulling on the fishing line 18 causes the head 16 to pitch forwardly, as shown in FIG. 4, thereby pivoting the body 11 forwardly and bringing the hook 12 and lure 29 into an upraised position with the pincers 30 of the lure 29 raised in a defensive posture. A bass swimming by would typically avoid the jig 10 due to the appearance of a crayfish in a defensive posture. While the jig 10 is being pulled, the buoyant trailers 23 float upwardly and outwardly to conceal the weed guard 23 and the hook 12 while leaving the pincers 30 exposed to view.

Upon releasing tension in the fishing line 18, the body 11 pivots rearwardly allowing the lure 29 to lay flat on the bottom of water (see FIG. 3). Since the crayfish now appears in a non-defensive position, the bass being attracted to the jig 10, strikes and becomes impaled on the hook 12 of the jig 10.

The jig manufacturing process begins with placing hooks 12 into a two-piece silicone mold (not shown). The mold is then put into a centrifugal casting machine and spun while molten tin is poured into the machine filling the cavities in the mold in order to form the bodies 11 about the hooks 12. Thereafter, the jig pieces are removed from the mold and loaded into a racking system. Next, the jig pieces are painted and sprayed with a white base coat and then painted the desired color and top coated with a two-part urethane finish.

The invention thus provides a fishing jig which provides a natural appearance, is made of environmentally friendly materials, such as tin, and which is lead free.

Further, the invention provides a fishing jig with a virtually invisible weed guard.

Still further, the invention provides a fishing jig of relatively simple construction that can be used with a lure to simulate the actions of a crayfish and is particularly useful for fishing for bass and other predator species.

What is claimed is:

1. A fishing jig comprising
a body having a longitudinally curved bottom surface for pivoting on a flat surface;
a hook of predetermined weight extending longitudinally from said body at one end thereof; and
a head extending from said body at an opposite end from said hook in coplanar relation to said hook, said head being of a weight greater than said weight of said hook to roll said body on the flat surface in a direction of said head whereby said head is brought into contact with the flat surface with said hook in a raised position.

2. A fishing jig as set forth in claim 1 wherein said head has a recessed aperture for receiving a fishing line leader.

3. A fishing jig as set forth in claim 1 further comprising a collar extending between said head and said body and a skirt disposed about said collar, said skirt having an elastic band disposed about said collar and a plurality of buoyant trailers extending from said band, said trailers being of a length to extend beyond said hook.

4. A fishing jig as set forth in claim 3 wherein said body has a flat surface adjacent said collar for splaying said trailers outwardly thereof.

5. A fishing jig as set forth in claim 1 further comprising a weed guard extending from said body between said head and said hook, said weed guard being disposed in alignment with said hook and including a plurality of relatively stiff fibers of translucent material having a refractive index approximately equal to that of water.

6. A fishing jig as set forth in claim 5 wherein said fibers are made of vinylidene fluoride.

7. A fishing jig as set forth in claim 1 further comprising a trailer keeper on said hook adjacent said body for retaining a lure thereon.

8. A fishing jig as set forth in claim 7 wherein said lure is in the shape of a crayfish.

9. A fishing jig as set forth in claim 1 wherein said body is curved transversely for rocking from side to side on a flat surface.

10. A fishing jig as set forth in claim 1 wherein said body is made of tin.

11. A fishing jig comprising
a body having a longitudinally curved bottom surface for pivoting on a flat surface;
a hook of predetermined weight extending longitudinally from said body at one end thereof;
a trailer keeper on said hook adjacent said body for retaining a lure thereon;
a head extending from said body at an opposite end from said hook in coplanar relation to said hook, said head being of a weight greater than said weight of said hook to roll said body on the flat surface in a direction of said head and having an aperture for receiving a fishing line leader; and
a collar extending between said head and said body.

12. A fishing jig as set forth in claim 11 further comprising a recess in said body; a weed guard extending from said body between said head and said hook, said weed guard being disposed in alignment with said hook and including a plurality of relatively stiff fibers of translucent material having a refractive index approximately equal to that of water; and a skirt having an elastic band disposed about said collar and a plurality of trailers extending from said band of a length to extend beyond said hook and said weed guard.

13. A fishing jig as set forth in claim 12 wherein said fibers are made of vinylidene fluoride.

14. A fishing jig as set forth in claim 11 further comprising a lure in the shape of a crayfish mounted on said trailer keeper.

15. A fishing jig as set forth in claim 11 wherein said body is curved transversely for rocking from side to side on a flat surface.

16. A fishing jig comprising
a head atone end;
a hook at a second end opposite said head; and
A weed guard extending intermediately from between said head and said hook, said weed guard being disposed in alignment with said hook and including a plurality of relatively stiff fibers of translucent material having a refractive index approximately equal to that of water.

17. A fishing jig as set forth in claim 16 wherein said fibers are made of vinylidene fluoride.

18. A fishing jig as set forth in claim 17 wherein said hook has a curved portion coplanar with said weed guard and a point at an end of said portion directed towards said weed guard.

19. A fishing jig as set forth in claim 16 further comprising a body between said head and said hook, said body having a recess receiving said fibers in fixedly secured relation.

20. A fishing jig as set forth in claim 16 wherein said body is made of tin.
